(19) United States
(12) Patent Application Publication
(10) Pub. No.: US 2007/0104488 A1
(43) Pub. Date: May 10, 2007

(54) Optical circuit and linear system dedicated node apparatus, linear system WDM network, and tree system WDM network using such

(75) Inventors: Hideyuki Miyata, Kawasaki (JP); Yutaka Kai, Kawasaki (JP); Setsuo Yoshida, Yokohama (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/643,976

(22) Filed: Dec. 22, 2006

Related U.S. Application Data
(63) Continuation of application No. PCT/JP04/09822, filed on Jul. 9, 2004.

(51) Int. Cl. H04J 14/02

(52) U.S. Cl. 398/83

(57) ABSTRACT

The optical circuit is attachable to a ring system dedicated node apparatus, which performs add/drop on an optical signal received from a first network and transmits to a second network, so as to convert into a linear system dedicated node apparatus that performs add/drop on an optical signal received from the first or second network and transmit to the second or first network. The optical circuit includes an optical filter having a characteristic of reflecting an optical signal band supplied from the second network and transmitting an optical signal band supplied from the first network, and transmitting an occupied band of an add light in the ring system dedicated node apparatus to which the own circuit is attached at a predetermined transmission rate and reflecting the reminder. The ring system dedicated node apparatus is used in common with a part of the linear system dedicated node apparatus.

### CROSS REFERENCE TO RELATED APPLICATION

This application is a U.S. continuation application, filed under 35 USC 111(a) and claiming the benefit under 35 USC 120 and 365(c), of PCT application JP2004/009822 filed Jul. 9, 2004. The foregoing application is hereby incorporated herein by reference.

### BACKGROUND OF THE INVENTION

1. Field of the Invention

The present invention generally relates to optical circuits and, more particularly, to an optical circuit, which converts a ring dedicated node apparatus into a linear system dedicated node apparatus by being attached to the ring dedicated node apparatus and a linear system dedicated node apparatus, a linear system WDM network and a tree system WDM network using such an optical circuit.

2. Description of the Related Art

FIG. 1A shows a structure diagram of an example of a ring system WDM (Wavelength Division Multiplexer) network. In the figure, node apparatuses 10a-10d exclusive for a ring system constitute a ring network and perform add/drop of an optical signal. In the ring network, the optical signal is transmitted in a single direction (a counterclockwise direction).

FIG. 1B shows an explanatory illustration of the node apparatuses 10a-10d for a ring topology network (hereinafter, referred to as ring system dedicated). Here, a description will be given of the node apparatus 10a as an example. In the figure, the node apparatus 10a receives a WDM signal from the ring network at an input port 11, and transmits a WDM signal to the ring network from an output port 12. An add light input through an input port 13 is multiplexed and transmitted from the output port 12, and a drop light received and demultiplexed by the input port 11 is output from an output port 14. The node apparatus 10a is provided with a filter at the input port to terminate an add light of its own node so as to prevent the add light of its own node from being input after going round the ring network.

FIG. 2A shows a structure diagram of an example of a tree system WDM network. Node apparatuses 20a-20f exclusive for a ring system constitute a tree-type network and perform add/drop of an optical signal. In the tree-type network, the optical signal is transmitted in both left and right directions.

FIG. 2B shows an explanatory illustration of the node apparatuses 20a-20f for a linear topology network (hereinafter, referred to as linear system dedicated node apparatuses) used for a tree system WDM network. Here, a description will be given of the node apparatus 20a as an example. In the figure, the node apparatus 20a performs reception and transmission by an input/output port 21 with respect to a network connected on the left side, and performs reception and transmission by an input/output port 22 with respect to a network connected on the right side. An add light input through an input port 23 is multiplexed and transmitted to the networks from the input/output ports 21 and 22, and a drop light received and demultiplexed by the input/output ports 21 and 22 is output from an output port 24. It should be noted that a node 25 is constituted by a star coupler that is a combination of 1×2 optical couplers, as shown in FIG. 2C.

The node apparatuses 10a-10d shown in FIG. 1(B) and the node apparatuses 20a-20f are different in their internal structures, and there is a problem in that both cannot be used in common.

Meanwhile, Patent Document 1 discloses a node apparatus for bidirectional optical communication performing bidirectional optical communication by transmitting optical signals of different wavelengths in both directions, comprising a unidirectional signal processing part that applies predetermined optical signal processing to an optical signal transmitted in a single direction and a unidirectional/bidirectional conversion processing part that causes a flow of each of optical signals of upward direction and downward direction to be in unidirectional and, on the other hand, causes a flow of optical signals from the unidirectional optical signal processing part to be in bidirectional so that bidirectional wavelength multiplex communication can be performed using an existing node apparatus for unidirectional optical communication.

Patent Document 1: Japanese Laid-Open Patent Application No. 11-127121

However, the method recited in Patent Document 1 must divide a wavelength band of an optical signal to be transmitted to a network connected on the left side of the node apparatus and a wavelength band of an optical signal to be transmitted to a network connected on the right side of the node apparatus. Thus, there is a problem in that a number of transmitters and a number of occupied wavelengths in the transmission path of the network need to be twice a number of transmission signals.

Moreover, in a linear system WDM network shown in FIG. 3, when performing transmission from a node apparatus 32 to networks connected on left and right sides using the same wavelength, an optical signal added in the node apparatus 32 is dropped by each of node apparatuses 31 and 33. For example, when a malfunction occurs in the network connected on the right side of the node apparatus 33 and a reflection of an optical signal occurs at the position where the malfunction occurs, an optical signal added in the node apparatus 32 is reflected at the position where the malfunction occurs and is dropped at each of the node apparatuses 31 and 33. Thus, a coherent cross-talk occurs, which deteriorates signals. Additionally, even if the above-mentioned problem does not occur, there is a problem in that a Rayleigh scattered light in a transmission path or a reflected light at an end surface of a connector causes a coherent cross-talk, which deteriorates optical signals.

### SUMMARY OF THE INVENTION

It is a general object of the present invention to provide an optical circuit in which the above-mentioned problems are eliminated.

A more specific object of the present invention is to provide an optical circuit that causes a ring system dedicated node apparatus to be used in common as a part of a linear system dedicated node apparatus by attaching to a ling system dedicated node apparatus to convert into a linear system dedicated node apparatus, and a linear system dedicated node apparatus, a linear system WDM network and a tree system WED network using such an optical circuit.

In order to achieve the above-mentioned objects, there is provided according to the present invention an optical circuit that is attachable to a ring system dedicated node apparatus, which performs add/drop on an optical signal received from a first network and transmits to a second network, so as to convert into a linear system dedicated node apparatus that performs add/drop on an optical signal received from the first or second network and transmit to the second or first network, the optical circuit comprising an optical filter having a characteristic of reflecting an optical signal band supplied from the second network and transmitting an optical signal band supplied from the first network, and transmitting an occupied band of an add light in the ring system dedicated node apparatus to which the own circuit is attached at a predetermined transmission rate and reflecting the reminder.

According to the above-mentioned optical circuit, the ring system dedicated node apparatus can be used in common with a part of the linear system dedicated node apparatus by attaching the optical circuit to the ring system dedicated node apparatus to convert the ring system dedicated node apparatus into the linear system dedicated node apparatus.

### BRIEF DESCRIPTION OF DRAWINGS

FIG. 1A is a structure diagram of a ring system dedicated WDM network;

FIG. 1B is an illustration of a ring system dedicated node apparatus;

FIG. 2A is a structure diagram of a tree system WDM network;

FIG. 2B is an illustration of a linear system dedicated node apparatus;

FIG. 2C is a structure diagram of a node shown in FIG. 2A;

FIG. 3 is an illustration for explaining a malfunction in a linear system WDM network;

FIG. 4 is a structure diagram of a ring system dedicated node apparatus according to an embodiment of the present invention;

FIG. 5 is a structure diagram of a ring system WDM network having the ring system dedicated node apparatus shown in FIG. 4;

FIG. 6 is a structure diagram of a linear system WDM network according to a first embodiment of the present invention using an optical circuit of the present invention;

FIG. 7A is a side view of an optical filter shown in FIG. 6;

FIG. 7B is a side view of an optical filter shown in FIG. 6;

FIG. 8A is a structure diagram of an embodiment of a linear system WDM network constituted by the linear system dedicated node apparatuses of the present invention;

FIG. 8B is a transmission/reflection characteristic diagram of an optical filter shown in FIG. 8A;

FIG. 9A is a structure diagram of a node apparatus for explaining optical paths when a failure occurs in the node apparatus;

FIG. 9B is a structure diagram of the node apparatuses shown in FIG. 8A for explaining optical paths when a failure occurs in the node apparatuses;

FIG. 10A is a structure diagram of a tree system WDM network constituted by connecting three linear system WDM networks using a star coupler;

FIG. 10B is an illustration for explaining nodes that transmit a signal light from the left side and nodes that transmit a signal light from the right side, viewed from each node;

FIG. 11 is a transmission/reflection characteristic diagram of an optical filter of each node apparatus of the tree system WDM network of FIG. 10A;

FIG. 12 is a block diagram of a node apparatus of a simplified structure which does not need to receive a WDM signal from a network on the right side;

FIG. 13A is a structure diagram of a network for explaining prevention of coherent cross-talk when using the node apparatus shown in FIG. 12;

FIG. 13B is a structure diagram of another network for explaining prevention of coherent cross-talk when using the node apparatus shown in FIG. 12;

FIG. 14 is a block diagram of a linear system dedicated node apparatus according to a second embodiment using an optical circuit according to the present invention; and

FIG. 15 is a block diagram of a linear system dedicated node apparatus according to a third embodiment using an optical circuit of the present invention.

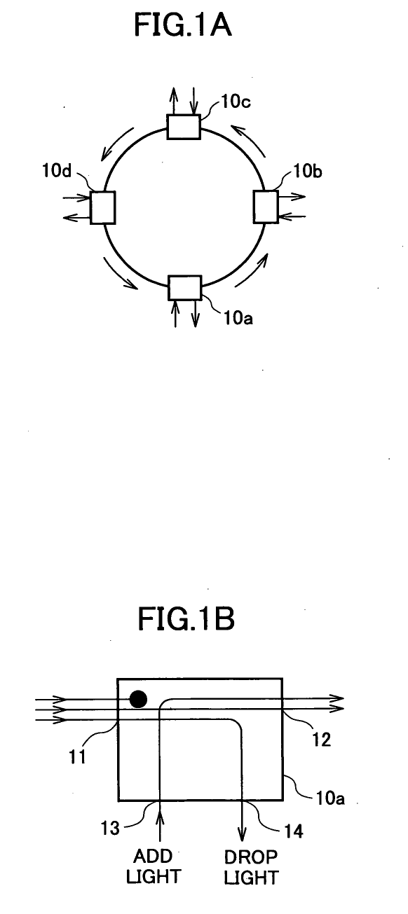

### DETAILED DESCRIPTION OF THE PREFERRED EMBODIMENTS

A description will now be given of embodiments according to the present invention.

FIG. 4 is a block diagram of a ring system dedicated node apparatus according to an embodiment of the present invention. The ring system dedicated node apparatus shown in FIG. 4 performs add/drop on an optical signal received from a network connected on the left side and transmits the optical signal to a network connected on the right side.

In FIG. 4, a ring system dedicated node apparatus 40 receives a WDM signal from a ring network by an input port 41, and transmits the WDM signal to a ring network from an output port 42. Add lights of wavelengths of λ1, λ2, λ3 and λ4 are supplied to and multiplexed by a 1×4 optical coupler 45, and are supplied to a reject and add filter 46.

The reject and add filter 46 removes occupied bands of the wavelengths λ1, λ2, λ3 and λ4 of the add light in the WDM signal supplied from the input port 41, and thereafter multiplexes the multiplexed add light (wavelengths of λ1, λ2, λ3 and λ4 supplied from the 1×4 optical coupler 45 and supplies the add light to a 1×2 optical coupler 47. The 1×2 optical coupler 47 branches the WDM signal from the reject and add filter 46, and outputs one of the branched signal from an output port 42 and supplies the other branched signal to a 1×4 optical coupler 48. It should be noted that the 1×2 optical coupler 47 outputs from an output port 42 75% of the WDM signal from the reject and add filter 46, and supplies 25% to the 1×4 optical coupler 48.

The 1×4 optical coupler 48 branches the above-mentioned WDM signal into four signals and supplied the signals to a variable optical filters 49a-49d. The variable optical filters 49a-49d demultiplex drop lights of wavelength of λi, λj, λk, and λl from the WDM signal, respectively, and output them from an output port 44. Although λ1-λ4≠λi-λl in a usual state where communication with other node apparatuses is performed, the wavelengths λi-λl may be set to one of the wavelength λ1-λ4 in order to identify a cause of a malfunction.

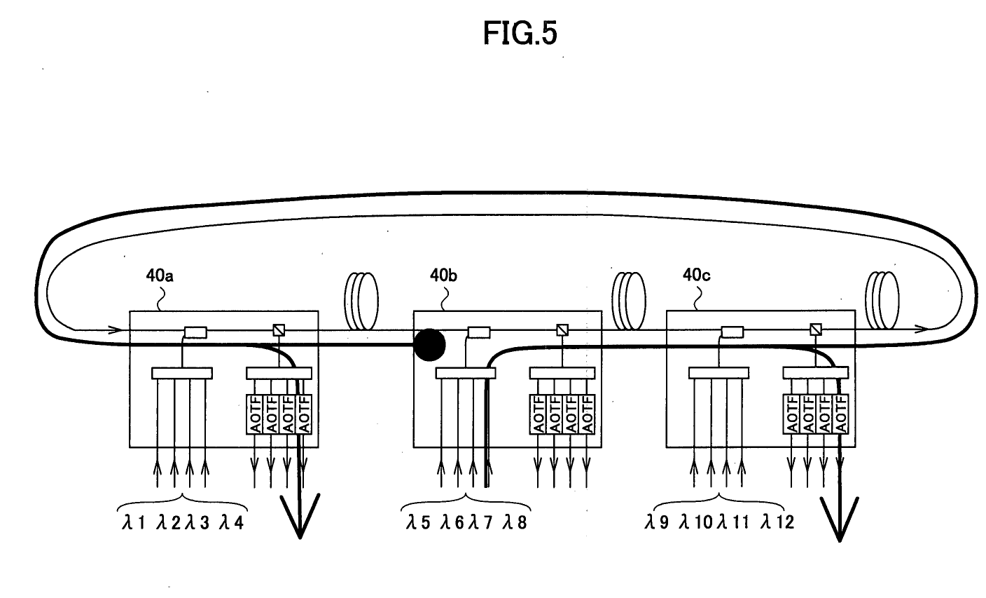

The above-mentioned ring system dedicated node apparatus 40 is used as node apparatuses 40a, 40b and 40c of the ring system WDM network shown in FIG. 5. Here, occupied areas of the add lights of the node apparatuses 40a, 40b and 40c are different from each other. For example, an add light of the wavelength of λ8 added by the node apparatus 40b is dropped by each of the node apparatuses 40c and 40a, and, thereby received by the node apparatuses 40c and 40a simultaneously.

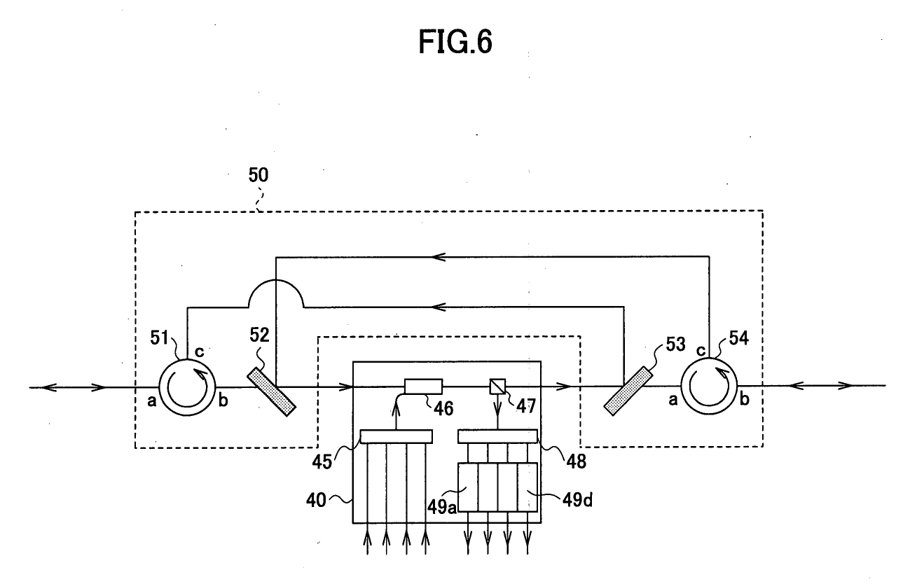

FIG. 6 is a block diagram of a linear system dedicated node apparatus according to a first embodiment that is configured using an optical circuit according to the present invention. The linear system dedicated node apparatus performs add/drop on an optical signal received from a network connected on the left side so as to send the optical signal to a network connected on the right side, and performs add/drop on an optical signal received from the network connected on the right side so as to send the optical signal to the network connected on the left side.

In FIG. 6, the linear system dedicated node apparatus comprises a ring system dedicated node apparatus 40 having the same structure as that shown in FIG. 4 and an optical circuit 50.

The optical circuit 50 comprises circulators 51 and 54 and optical filters 52 and 53. The circulator 51 has a first port a connected to the network on the left side, a second port b connected to the optical filter 52, and a third port c connected to the filter 53, wherein an optical signal input through the first port a is output from the second port b and an optical signal input through the third port c is output from the first port a.

The optical filter 52 has 100% transmittance with respect to an optical signal band supplied from the network connected on the left side and 100% reflectance with respect to an optical signal band supplied from the network connected on the right side. Any transmittance from 0% through 100% (100% -0% reflectance) may be used with respect to occupied band of an add light of the node apparatus 40. Thereby, it is possible to select the same transmittance with the optical filter 53 mentioned later. The optical signal transmitted through the optical filter 52 and the optical signal reflected by the optical filter 52 are supplied to a reject and add filter 46 of the node apparatus 40.

The optical filter 53 has 100% transmittance with respect to an optical signal band supplied from the network connected on the left side and 100% reflectance with respect to an optical signal band supplied from the network connected on the right side, and has a predetermined transmittance with respect to an occupied band of an add light of the node apparatus 40. The predetermined transmittance is determined by a position of a network on which the node apparatus is provided. If it is located near the center of the network, the transmittance is set to 50% (50% transmittance). If the right side of the node apparatus 40 is neat an end of the network, the transmittance is decreased (increasing reflectance) so as to set the filter characteristic to increase an add light transmitted to the center of the network is increased since a number of node apparatuses connected on the lift side of the node apparatus 40 is large.

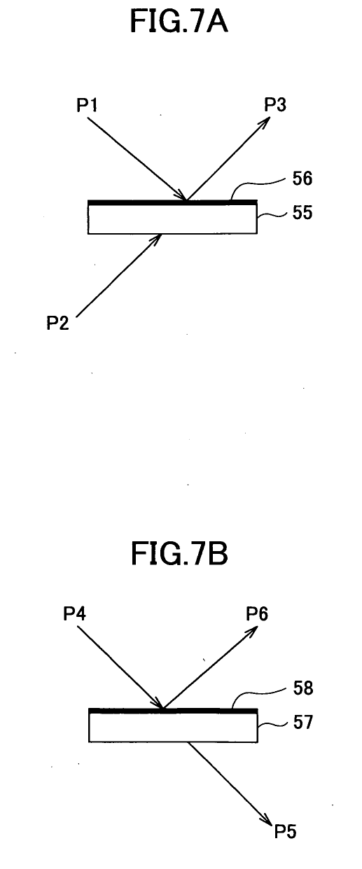

FIG. 7A is a side view of the optical filter 52. In FIG. 7A, an optical transmission film 56 is provided on a surface of a transparent substrate 55. An optical signal from the circulator 54 is supplied to a port P1, and an optical signal band supplied from the network connected on the right side transmits through the transparent film 56 and the optical transmission film 56 and multiplexed with an optical signal band supplied from the network connected on the right side, which is reflected by the optical transmission film 56, and exits toward the ring system dedicated node apparatus 40 from a port P3.

FIG. 7B is a side view of the optical filter 53. In FIG. 7B, an optical transmission film 58 is provided on a surface of a transparent substrate 57. An optical signal from the ring system dedicated node apparatus 40 is supplied to a port P4. An optical signal band of the optical signal supplied from the network connected on the left side and a part of an add light of the node apparatus 40 transmit through the transparent substrate 57 and the optical transmission film 58 and exit from a port P5 toward the circulator 54. On the other hand, an optical signal band supplied from the network connected on the right side and the rest of the add light of the node apparatus are reflected by the optical transmission film 58, and exit from a port P6 toward the circulator 51.

The circulator 54 has a first port a connected to the optical filter 53, a second port b connected to the network on the right side, and a third port c connected to the optical filter 52, wherein an optical signal input through the second port b is output from the third port c, and an optical filter input through the first port a is output from the second port b.

An optical signal supplied from the left side in FIG. 6 is supplied to the reject and add filter 46 of the node apparatus 40 through the circulator 51 and the optical filter 52 so as to remove an add light occupied band of the node apparatus 40. Then, a part of the optical signal is split by the 1×2 optical coupler 47 toward a 1×2 optical coupler 48, and the rest of the optical signal transmits through the optical filter 53 and sent to the network on the right side through the circulator 54.

On the other hand, an optical signal supplied from the right side in FIG. 6 is supplied to the reject and add filter 46 of the node apparatus 40 through the circulator 54 and the optical filter 52 so as to remove an add light occupied band of the node apparatus 40. Then, a part of the optical signal is split by the 1×2 optical coupler 47 toward the 1×2 optical coupler 48, and the rest of the optical signal is reflected by the optical filter 53 and sent to the network on the left side through the circulator 51.

A WDM signal added by the reject and add filter 46 of the node apparatus 40 is supplied to the optical filter 53 through the 1×2 optical coupler 47, and a part of the optical signal reflected by the optical filter 53 is sent to the network on the left side through the circulator 51. A part of the optical signal transmitted through the optical filter 53 is sent to the network on the right side through the circulator 54.

Thus, the ring system dedicated node apparatus can be used as a part of a ring system dedicated node apparatus.

In the meantime, as for the optical filters 52 and 53, a variable optical filter such as disclosed in the following Document 1 may be used, which is of a single input and double output type and the two outputs have inverse characteristics to each other.

Document 1: “wide band programmable optical frequency filter”, Shiyo Jingu, electronic-intelligence communication society papers, C-I Vol. J81-C-I No. 4, pp. 254-263, April 1998

If such a variable optical filter is used as the optical filters 52 and 53, a wavelength characteristic in each of linear system dedicated node apparatuses in a tree system WDM network can be changed by a management apparatus which manages the tree system WDM network so that add light occupied bands do not overlap with each other, and also positions of the linear system dedicated node apparatuses in the tree system network can be changed freely by changing transmittance of the add light occupied bands.

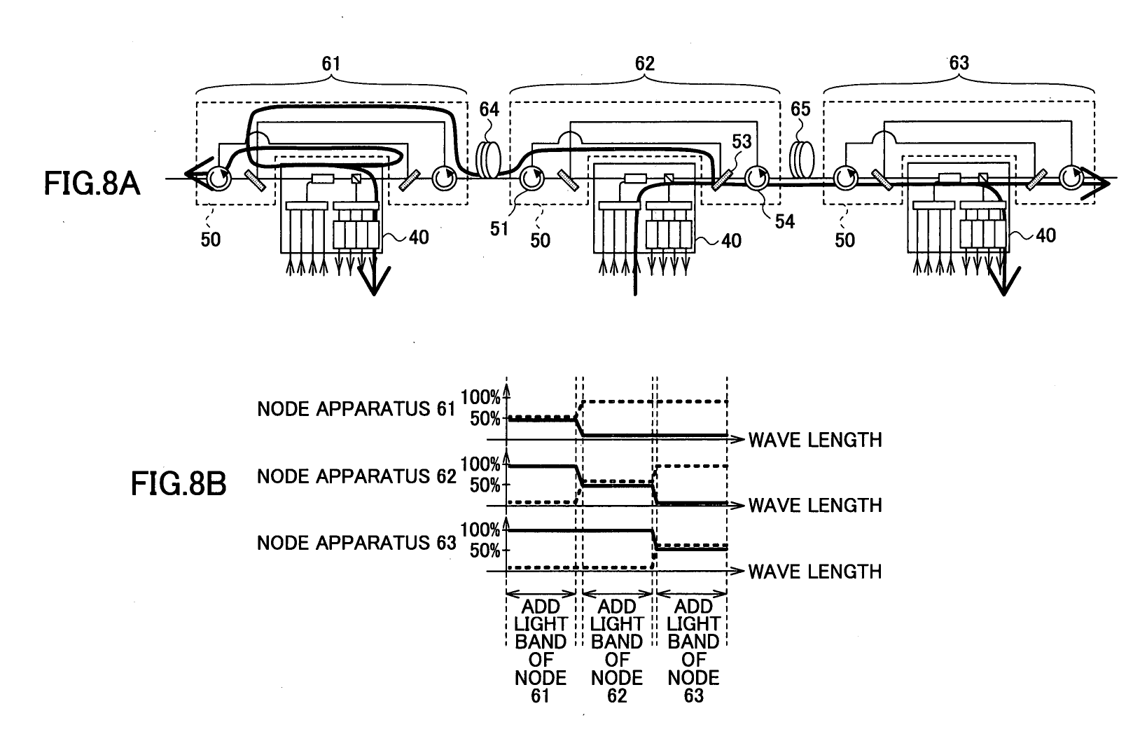

FIG. 8A is a block diagram of an embodiment of a linear system WDM network constituted by the linear system dedicated node apparatus according to the present invention. In FIG. 8A, each node apparatus has the structure shown in FIG. 6, which comprises the ring system dedicated node apparatus 40 and the optical circuit 50. The node apparatus 61 and the node apparatus 62 are connected with each other by an optical fiber transmission path 64, and the node apparatus 62 and the node apparatus 63 are connected with each other by an optical fiber transmission path 65. Optical fiber transmission paths are connected to the left side of the node apparatus 61 and the right side of the node apparatus 63 so as to form a linear system WDM network. Add light occupied bands of the node apparatuses 61, 62 and 63 are set so that they do not overlap with each other.

FIG. 8B shows a transmission/reflection characteristic of the optical filter 53 of each of the node apparatuses 61, 62 and 63. The optical filters 52 and 53 of the node apparatus 61 have 50% transmittance and 50% reflectance in the add light occupied band of its own so as to exhibit a transmittance indicated by a solid line and a reflectance indicated by a dashed line in an upper part of FIG. 8B. Additionally, the optical filters 52 and 53 of the node apparatus 61 have 0% transmittance and 100% reflectance with respect to an optical signal (add light occupied bands of the node apparatuses 62 and 63) supplied from the network on the right side.

The optical filters 52 and 53 of the node apparatus have, as shown in the middle of FIG. 8B, 50% transmittance and 50% reflectance in the add light occupied band of its own, and have 100% transmittance and 0% reflectance in the band of the optical signal supplied from the network on the left side and 0% transmittance and 100% reflectance with respect to an optical signal (add light occupied band of the node apparatus 63) supplied from the network on the right side.

The optical filters 52 and 53 of the node apparatus 63 have, as shown in a lower part of FIG. 8B, 50% transmittance and 50% reflectance in the add light occupied band, and have 100% transmittance and 0% reflectance in a band (add light occupied bands of the node apparatuses 61 and 62) of an optical signal supplied from the network on the left side.

Accordingly, an add light of the node apparatus 62 is branched a indicated by an arrow in FIG. 8A by the optical filter 53 of the node apparatus 62. One of the branched add lights is sent to the optical fiber transmission path through the circulator 54, and, then, transmitted to the node apparatus 63 and the optical fiber transmission path beyond the node apparatus 63. The other of the branched add lights is sent to the optical fiber transmission path 64 through the circulator 51 of the node apparatus 62, and, then, transmitted to the node apparatus 61 and the optical fiber transmission path beyond the node apparatus 61. Thus, the ring system dedicated node apparatuses 40 constituting the node apparatuses 61 and 63 are capable of simultaneously receiving optical signals added by the node apparatus 62.

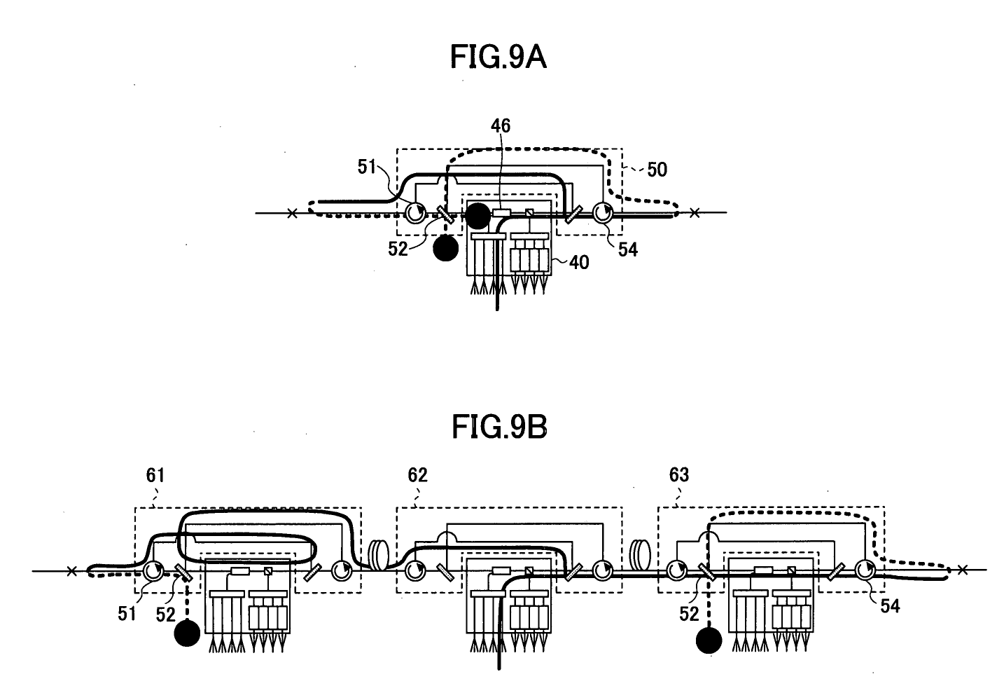

When a failure occurs in the network connected on the right side of the optical circuit 50 and a reflection of the optical signal occurs at a position where the failure occurs as shown in FIG. 9A, the optical signal added by the node apparatus 40 is reflected (as indicated by a dashed line) at the position where the failure occurs, and supplied to the optical filter 52 through the circulator 54. A part of the optical signal reflected by the optical filter 52 is removed by the reject and add filter 46, and the optical signal transmitted through the optical filter 52 is output to a non-coupled port and removed.

On the other hand, when a failure occurs in the network connected on the left side of the optical circuit 50 and a reflection of the optical signal occurs at a position where the failure occurs, the optical signal added by the node apparatus 40 is reflected (as indicated by a dashed line) at the position where the failure occurs, and supplied to the optical filter 52 through the circulator 51. A part of the optical signal transmitted through the optical filter 52 is removed by the reject and add filter 46, and the optical signal reflected by the optical filter 52 is output to the non-coupled port and removed.

When a failure occurs in the network connected on the right side of the ode apparatus 63 in the linear system WDM network constituted by the node apparatuses 61, 61 and 63 and a reflection of the optical signal occurs at the position where the failure occurs as shown in FIG. 9B, the optical signal added by the node apparatus 61 is reflected (as indicated by a dashed line) at the position where the failure occurs, and supplied to the optical filter 52 through the circulator 54 of the node apparatus 63. A reflected component of the add light of the ode apparatus 62 is removed by causing occupied band of the add light of the node apparatus 62 to transmit therethrough and output to a non-coupled port.

Moreover, when a failure occurs in the network connected on the left side of the node apparatus 61 and a reflection of an optical signal occurs at a position where the failure occurs, the optical signal added by the node apparatus 62 is reflected (indicated by a dashed line) at the position where the failure occurs and supplied to the optical filter 52 through the circulator 51 of the node apparatus 61. The optical filter 52 of the node apparatus 61 reflects the whole occupied band of the add light of the ode apparatus 62 and output it to a non-coupled port, and, thereby, the reflection component of the add light is removed.

Therefore, the optical signal is prevented from being deteriorated due to a coherent cross talk caused by a Rayliegh scattered light in a transmission path or an obstacle and a reflection light at an end surface of a connector. Additionally, there is no need to separate a wavelength band of an optical signal to be sent to the network connected on the left side of the node apparatus from a wavelength band of an optical signal to be sent to the network connected on the right side of the node apparatus, and, hereby, a number of transmitters and a number of occupied wavelengths in the transmission path of the network can be equal to a number of signals to transmit.

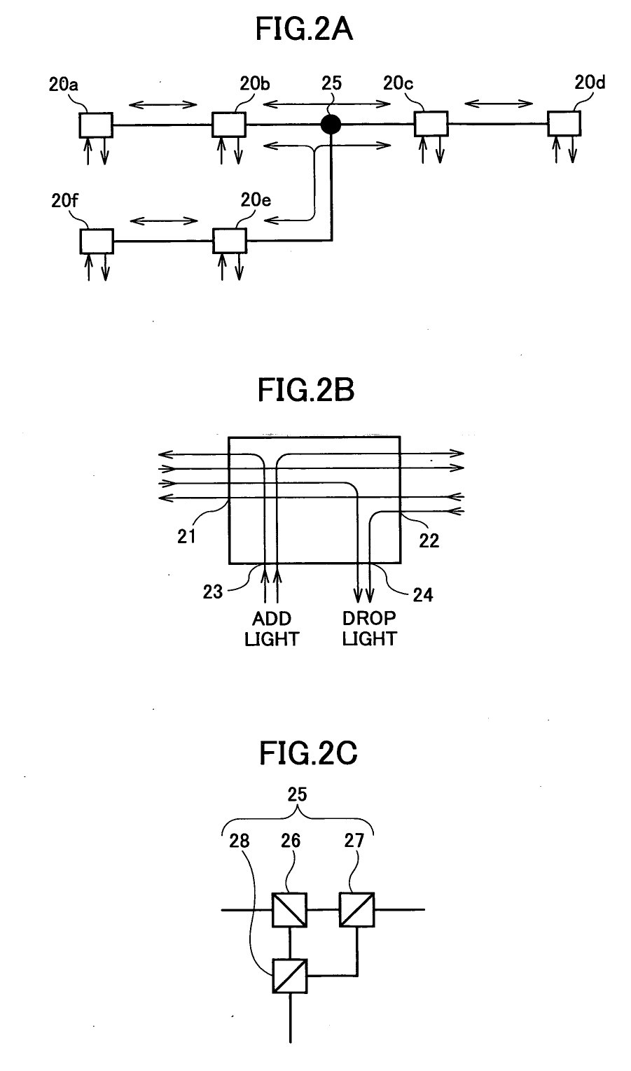

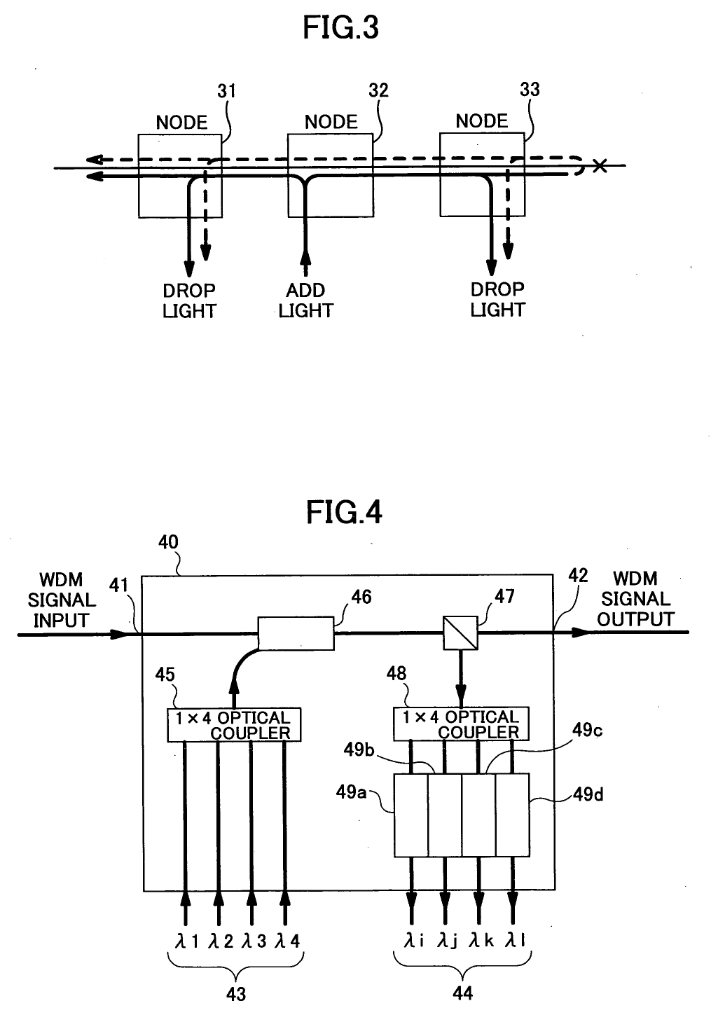

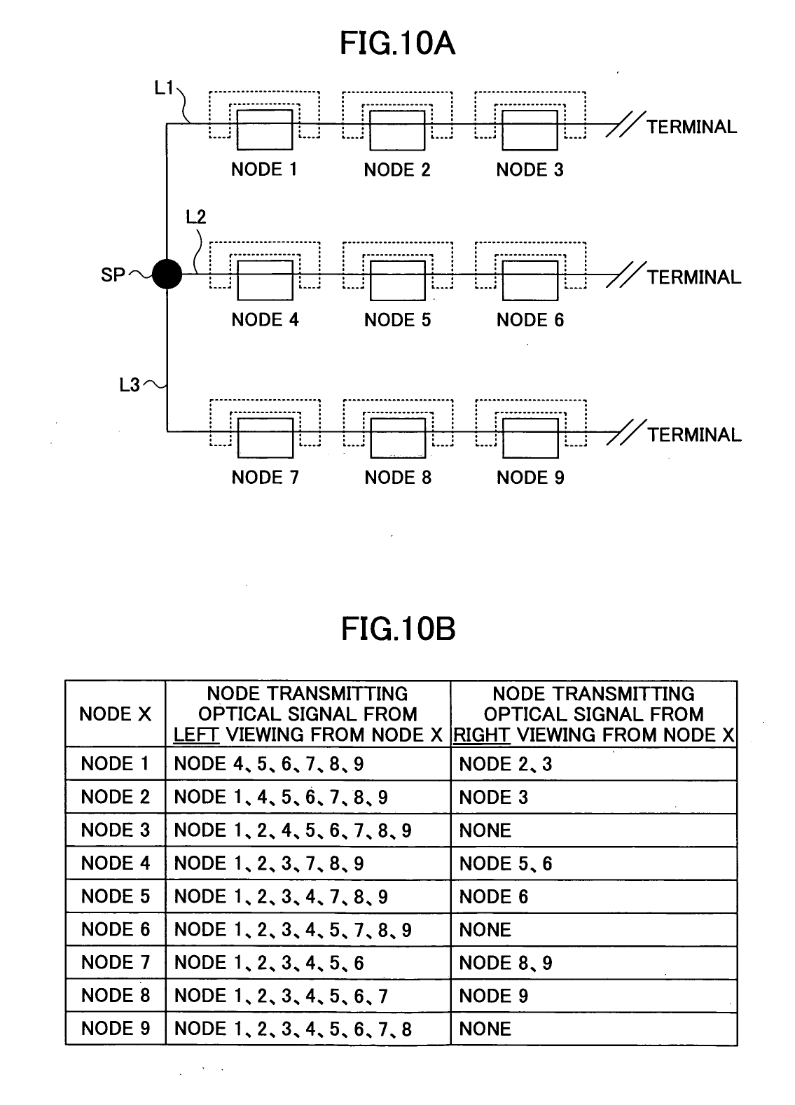

A description will now be given of a tree system WDM network constituted by connecting three linear system WDM networks L1, L2, L3 using a star coupler SP as shown in FIG. 10A. In the figure, the network comprises node apparatuses 1 through 9. Each of the node apparatuses 1 through 9 has the same structure as that shown in FIG. 6, and an add light occupied bands of the node apparatuses are set so that they do not overlap with each other. The network is terminated on the right side of each of the node apparatuses 3, 6 and 9. Thus, each of the node apparatuses 3, 6 and 9 does not need to receive a signal from the network on the right side. FIG. 10B shows a node that transmits a signal light (WDM signal) from the left side viewed from each node X (X=1 through 9) and a node that transmits a signal light from the right side. It should be noted that the star coupler has the same structure as that shown in FIG. 2C.

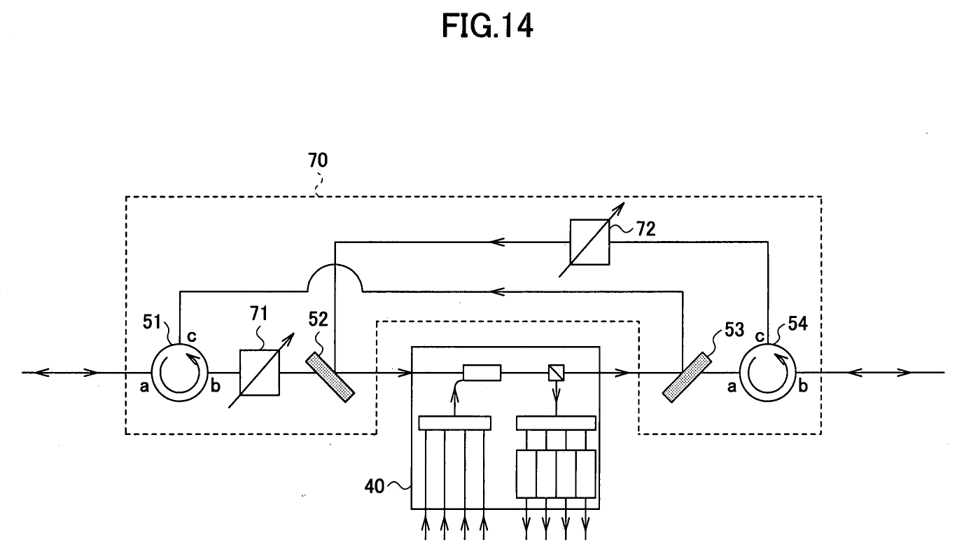

FIG. 14 is a block diagram of a linear system dedicated node apparatus according to a second embodiment using an optical circuit according to the present invention. It should be noted that numbers indicated along the horizontal axis are the numbers of the node apparatuses.

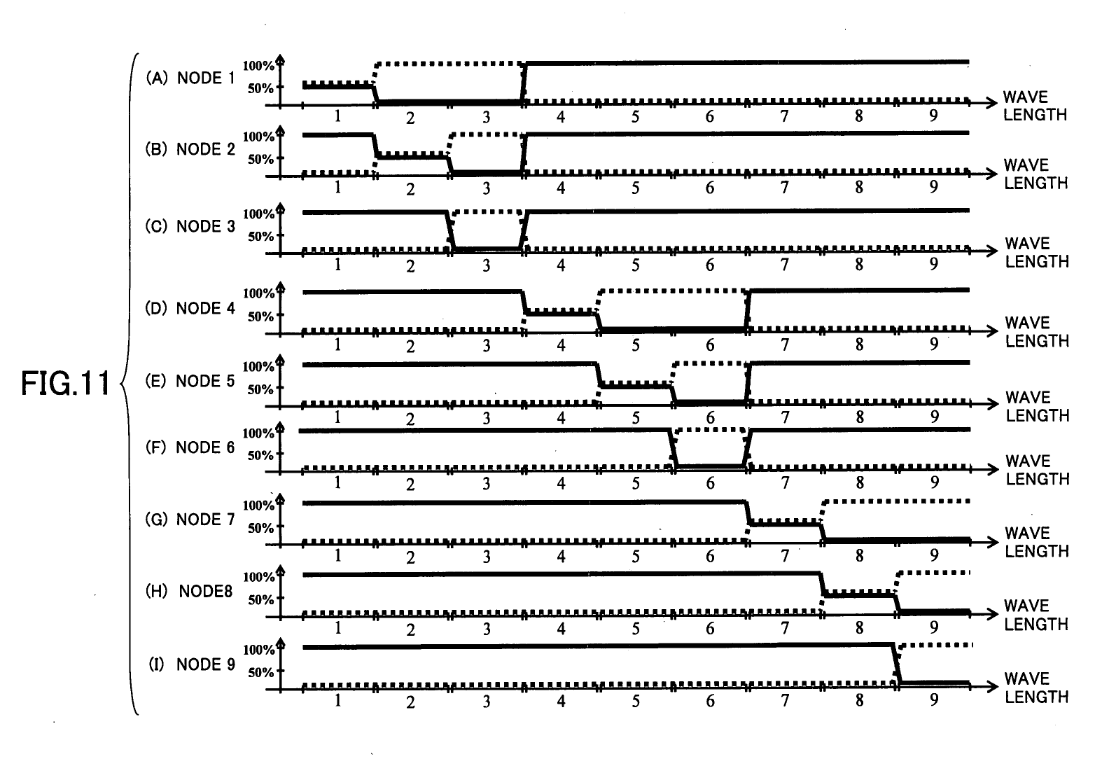

For example, as shown in FIG. 11-(A), the optical filters 52 and 53 of the node apparatus 1 have 50% transmittance and 50% reflectance in the add light occupied band of its own, 100% transmittance and 0% reflectance with respect to optical signal bands (add light occupied bands of the node apparatuses 4 through 9) supplied from the left side, and 0% transmittance and 100% reflectance with respect to optical signal bands (add light occupied bands of the node apparatuses 2 and 3) supplied from the right side.

Additionally, as shown in FIG. 11-(B), the optical filters 52 and 53 of the node apparatus 2 have 50% transmittance and 50% reflectance in the add light occupied band of its own, 100% transmittance and 0% reflectance with respect to optical signal bands (add light occupied bands of the node apparatuses 1 and 4 through 9) supplied from the left side, and 0% transmittance and 100% reflectance with respect to an optical signal band (add light occupied band of the node apparatus 1) supplied from the right side. Similarly, other node apparatuses 3 through 9 have transmittance and reflectance shown in FIG. 11-(C) through 11-(I).

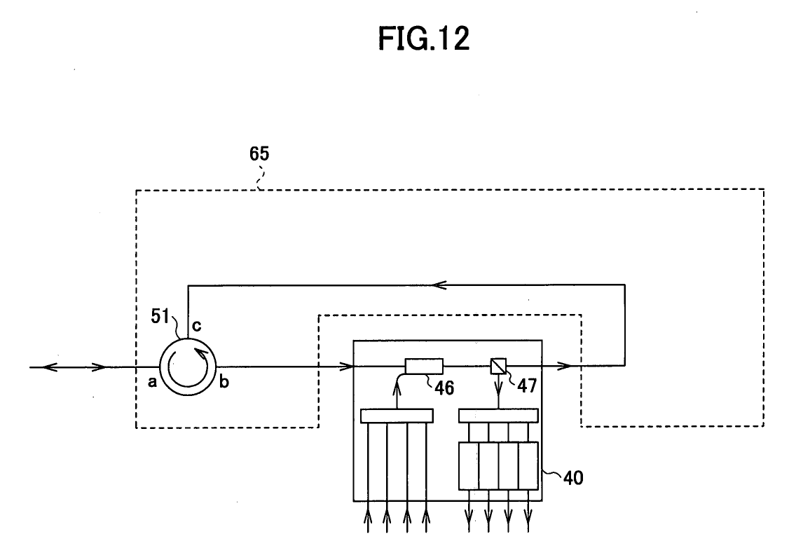

With respect to the node apparatuses 3, 6 and 9 that do not need to receive a WDM signal from the network on the right side, the simplified structure shown in FIG. 12 can be used. In FIG. 12, an optical circuit 65 is constituted by the circulator 51 alone. The circulator has the first port a connected to the network on the left side, the second port b connected to the reject and add filter 46 of the ring system dedicated node apparatus 40, the third port c connected to the 1×2 optical coupler 47 of the node apparatus 40.

Although optical signals added by other node apparatuses and supplied from the network on the left side make a round and return to the network on the left side, if the optical filters 52 and 53 of the node apparatuses other than the node apparatuses 3, 6 and 9 have ideal characteristics, a coherent cross talk can be prevented.

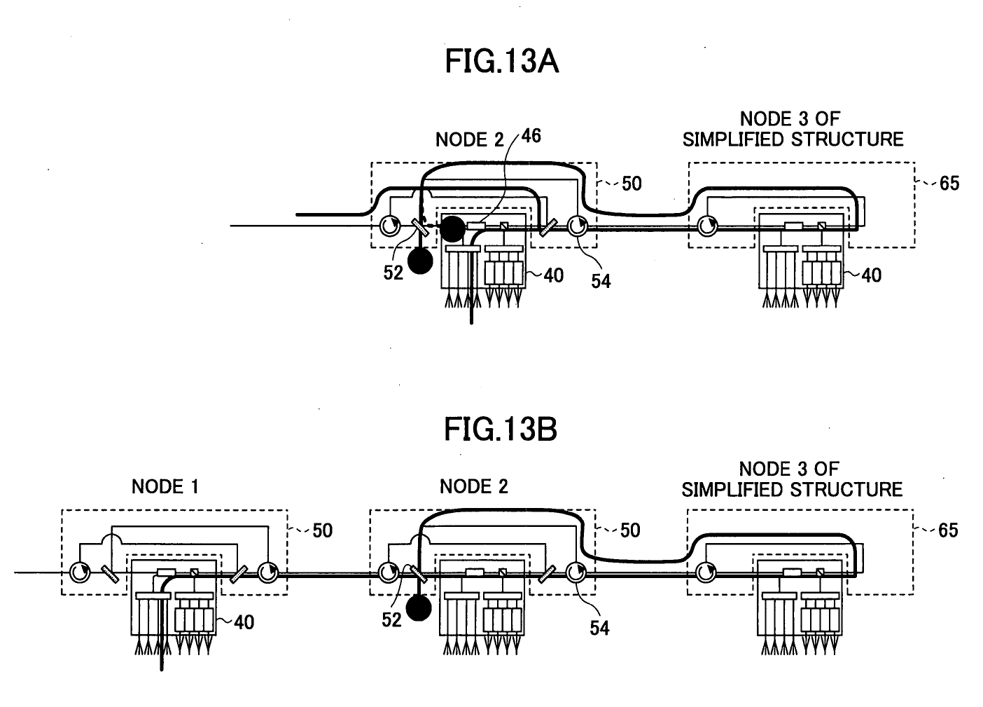

As shown in FIG. 13A, an optical signal added by the node apparatus 2 makes a round in the optical circuit 65 of the node apparatus 3 and returns to the node apparatus 2. Then the optical signal goes through the circulator 54 and supplied to the optical filter 52 in the node apparatus 2. A part of the optical signal reflected by the optical filter 52 is removed by the reject and add filter 46, and a part of the optical signal transmitted through the optical filter 52 is output to the non-coupled port and removed.

As shown in FIG. 13B, an optical signal added by the node apparatus 1 and passed through the node apparatus 2 makes a round in the optical circuit 65 of the node apparatus 3 and returns to the node apparatus 2. Then, the optical signal goes through the circulator 54 and supplied to the optical filter 52 in the node apparatus 2, and is transmitted through the optical filter 52 and output to the non-coupled port and removed.

FIG. 14 is a block diagram of a linear system dedicated node apparatus according to a second embodiment using an optical circuit according to the present invention. The optical circuit 70 shown in FIG. 14 differs from the optical circuit 50 shown in FIG. 6 in that a variable optical attenuator 71 is connected between the circulator 51 and the optical filter 52 and a variable optical attenuator 72 is connected between the optical filter 52 and the circulator 54.

In this embodiment, if a light intensity of a WDM signal received from the network on the left side differs from a light intensity of an add light of its own, the WDM signal received from the network on the left side is attenuated by the variable optical attenuator 71 so as to match the light intensity of the add light of its own. Additionally, if a light intensity of a WDM signal received from the network on the right side differs from a light intensity of an add light of its own, the WDM signal received from the network on the right side is attenuated by the variable optical attenuator 72 so as to match the light intensity of the add light of its own. It should be noted that the optical circuit may be provided with only one of the variable optical attenuators 71 and 72.

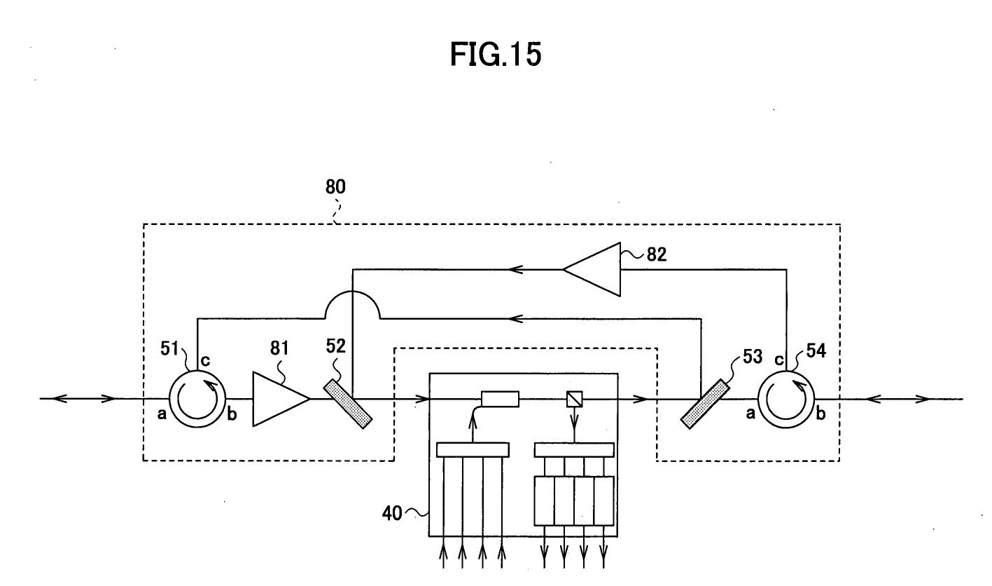

FIG. 15 is a block diagram of a linear system dedicated node apparatus according to a third embodiment using an optical circuit according to the present invention. The optical circuit 80 shown in FIG. 15 differs from the optical circuit 50 shown in FIG. 6 in that an optical amplifier 81 is connected between the circulator 51 and the optical filter 52 and an optical amplifier 82 is connected between the optical filter 52 and the circulator 54.

In this embodiment, if a light intensity of a WDM signal received from the network on the left side differs from a light intensity of an add light of its own, the WDM signal received from the network on the left side is amplified by the optical amplifier 81 so as to match the light intensity of the add light of its own. Additionally, if a light intensity of a WDM signal received from the network on the right side differs from a light intensity of an add light of its own, the WDM signal received from the network on the right side is amplified by the optical amplifier 82 so as to match the light intensity of the add light of its own. It should be noted that the optical circuit may be provided with only one of the optical amplifiers 81 and 82.

It should be noted that network connected on the left side corresponds to a first network in the present invention and the network connected on the right side corresponds to a second network in the present invention.

The present invention is not limited to the specifically disclosed embodiments, and variations and modifications may be made without departing from the scope of the present invention.

What is clamed is:

1. An optical circuit that is attachable to a ring system dedicated node apparatus, which performs add/drop on an optical signal received from a first network and transmits to a second network, so as to convert the ring system dedicated node apparatus into a linear system dedicated node apparatus that performs add/drop on an optical signal received from the first or second network and transmit to the second or first network, the optical circuit comprising:
an optical filter having a characteristic of reflecting an optical signal band supplied from the second network and transmitting an optical signal band supplied from the first network, and transmitting an occupied band of an add light in the ring system dedicated node apparatus to which the own circuit is attached at a predetermined transmission rate and reflecting the reminder.

2. An optical circuit that is attachable to a ring system dedicated node apparatus, which performs add/drop on an optical signal received from a first network and transmits to a second network, so as to convert the ring system dedicated node apparatus into a linear system dedicated node apparatus that performs add/drop on an optical signal received from the first or second network and transmit to the second or first network, the optical circuit comprising:
a first circulator connected to the first network;
a second circulator connected to the second network;
a first filter that transmits an optical signal band received from said first network and supplied through said first circulator, and reflects an optical signal band received from said second network and supplied through said second circulator; and
a second filter that transmits an optical signal band received from said first network and supplied through said first circulator, and reflects an optical signal band received from said second network and supplied through said second circulator with respect to an optical signal transmitted from said ring system dedicated node apparatus, and transmits an occupied band of an add light in said ring system dedicated node apparatus at a predetermined transmission rate and reflects the reminder, and transmits the transmitted optical signal to said second network through said second circulator and transmits the reflected optical signal to said first network through said first circulator.

3. The optical circuit as claimed in claim 2, wherein said predetermined transmission rate is set in accordance with a position of a network where said linear system dedicated node apparatus is located.

4. The optical circuit as claimed in claim 3, wherein said predetermined transmission rate is about 50% when said linear system dedicated node apparatus is in a vicinity of a center of a network.

5. The optical circuit as claimed in claim 3, wherein said predetermined transmission rate is a value such that an add light transmitted toward the center of the network is increased when said linear system dedicated node apparatus is in a vicinity of an end part of the network.

6. The optical circuit as claimed in claim 2, wherein at least one of said first and second filters is constituted by a variable optical filter.

7. The optical circuit as claimed in claim 2, further comprising:
a first variable optical attenuator inserted and connected between said first circulator and said first filter; and
a second variable optical attenuator inserted and connected between said second circulator and said first filter.

8. The optical circuit as claimed in claim 2, further comprising:
a first optical amplifier inserted and connected between said first circulator and said first filter; and
a second optical amplifier inserted and connected between said second circulator and said first filter.

9. A linear system dedicated node apparatus that is constituted by attaching the optical circuit as claimed in claim 2 to a ring system dedicated node apparatus, which performs add/drop on an optical signal received from a first network and transmits to a second network, so as to perform add/drop on an optical signal received from the first or second network and transmit to the second or first network.

10. A linear system WDM network configured by connecting a plurality of the linear system dedicated node apparatuses as claimed in claim 9.

11. A tree system WDM network configured by connecting a plurality of the tree system WDM networks as claimed in claim 10 by a star coupler.

12. The tree system WDM network as claimed in claim 11, wherein occupied bands of the add light in the linear system dedicated node apparatuses are different from each other.
